(19) United States
(12) Patent Application Publication
(10) Pub. No.: US 2011/0205918 A1
(43) Pub. Date: Aug. 25, 2011

(54) Apparatus for Power Line and Wireless Communications

(76) Inventor: Jonathan E. D. Hurwitz, Edinburgh (GB)

(21) Appl. No.: 12/972,302

(22) Filed: Dec. 17, 2010

Related U.S. Application Data
(63) Continuation-in-part of application No. 11/752,887, filed on May 23, 2007.
Application No. 11/752,887 is a continuation-in-part of application No. 11/536,539, filed on Sep. 28, 2006.
Application No. 11/536,539 is a continuation-in-part of application No. 11/467,141, filed on Aug. 24, 2006, now Pat. No. 7,899,436.
Application No. 11/752,887 is a continuation-in-part of application No. 11/562,380, filed on Nov. 21, 2006, now Pat. No. 7,808,985.
Application No. 11/562,380 is a continuation-in-part of application No. 11/619,167, filed on Jan. 2, 2007.

(30) Foreign Application Priority Data
Oct. 3, 2005 (EP) EP 05 256 179.2
Dec. 17, 2009 (GB) GB 0922091.4

(51) Int. Cl. H04W 84/02; H04W 24/00

(52) U.S. Cl. 370/252; 370/338

(57) ABSTRACT

A communications apparatus comprises a first medium interface circuit for communicating data over a power line, a first medium access controller, having a first MAC address, for controlling the first medium interface circuit, an 802.11 compliant second medium interface circuit for wireless data communications, a second medium access controller, having a second MAC address, for controlling the second medium interface circuit, and a communications medium access controller configured to apportion data for simultaneous communication over the wireless and power line media. The first medium interface circuit and the second medium interface circuit are linked at the layer II level of the OSI model. A network of said devices is also disclosed, the network possibly including device connected via only one of the media.

### CROSS-REFERENCES

This application claims under 35 U.S.C. 119 benefit of and priority to provisional application GB 0922091.4 filed Dec. 17, 2009 and is also a continuation-in-part of U.S. patent application Ser. No. 11/752,887 filed May 23, 2007 and entitled “Multi-Wideband Communications over Multiple Mediums” which is a continuation-in-part of U.S. patent application Ser. No. 11/536,539 filed Sep. 28, 2006 and entitled “Multi-Wideband Communications over Powerlines” which is a continuation-in-part of U.S. patent application Ser. No. 11/467,141 filed on Aug. 24, 2006 and entitled “Multi-Wideband Communications over Power Lines” which claims under 35 U.S.C. 119 benefit of and priority to European Patent Application EP 05 256 179.2, entitled “Power line Communication Device and Method,” filed Oct. 3, 2005; U.S. patent application Ser. No. 11/752,887 is also a continuation-in-part of U.S. patent application Ser. No. 11/562,380 filed Nov. 21, 2006 and entitled “Network Repeater;” and U.S. patent application Ser. No. 11/752,887 is further a continuation-in-part of U.S. patent application Ser. No. 11/619,167 filed Jan. 2, 2006 and entitled “Unknown Destination Traffic Repetition.” All of the above applications are incorporated herein by reference.

### BACKGROUND

1. Field of Invention

The present application relates generally to communications apparatus and network apparatus comprising such communications apparatus.

2. Description of the Related Art

Data communication between two modems by way of different media is known. For example, WO 2008/142449 describes a modem apparatus that is operative to transmit and receive data over power lines, telephone lines and coaxial cables. The apparatus can select a medium for communication based on quality of service requirements, such as latency and bandwidth. Typically, modems implements Ethernet based protocols that force communications through a single medium. For example, modems communicate wirelessly by means of an 802.11 compliant device in accordance with a spanning tree protocol, which is operative to reduce the likelihood of forming data loops.

### SUMMARY

An exemplary communications apparatus of the invention comprises two media interface circuits, two media access controllers, and a communications controller. One of the media interface circuits is a first wired medium interface circuit and is configured to communicate data over a first wired medium such as a coaxial cable or power line. The other medium interface circuit is a wireless medium interface circuit that is 802.11 compliant and that is configured to communicate data wirelessly. One of the media access controllers is a first medium access controller having a first MAC address and configured to control the first wired medium interface circuit. The other media access controller is a second medium access controller having a second MAC address and configured to control the wireless medium interface circuit. The communications controller is configured receive data packets and to apportion the data packets between the first and second medium access controllers to provide simultaneous data transmission over the first wired medium and the wireless medium by way of the first wired medium interface circuit and the wireless medium interface circuit. Further, the first wired medium interface circuit and the wireless medium interface circuit are linked at the layer II level of the OSI model. For example, the first wired medium interface circuit and the wireless medium interface circuit can be configured to communicate with one another using the Ethernet 802.3 standard.

Various embodiments of the exemplary communications apparatus further comprise a routing controller. The routing controller can comprise routing data, where the routing data identifies other apparatus with which the communications apparatus may communicate. Either or both of the first wired medium interface circuit and the wireless medium interface circuit can be configured to operate as a transceiver.

In various embodiments of the exemplary communications apparatus, the communications controller is configured to apportion the data packets based on a quality of service measure. The quality of service measure may comprise, for example, at least one of a bandwidth, a medium latency, an extent of packet loss, a type of data to be communicated, and a condition of the data to be communicated. In various embodiments the first medium access controller is also configured to measure a quality of the first wired medium, or the second medium access controller is configured to measure a quality of the wireless medium.

In various embodiments of the exemplary communications apparatus, the first and second medium access controllers and the wired and wireless medium interface circuits form part of a single System on a Chip. In some of these embodiments, the first and second Systems on a Chip are configured to communicate with one another using a frame based standard.

In various embodiments, the first medium access controller and the first wired medium interface circuit are formed as part of a first System on a Chip and the second medium access controller and the wireless medium interface circuit are formed as part of a second System on a Chip. In some of these embodiments the communications controller also forms part of the first System on a Chip. Alternatively, the communications controller can form part of the second System on a Chip. In some of these latter embodiments, the first System on a Chip comprises a second wired medium interface circuit, a third medium access controller, and a convergence layer controller configured to control the first and third medium access controllers. In these embodiments the second wired medium interface circuit is configured to communicate data over a second wired medium different than the first wired medium, and the third medium access controller has a third MAC address and is configured to control the second wired medium interface circuit.

Various embodiments of the exemplary communications apparatus include first and second units. In some of these embodiments the first unit includes the communications controller and the first wired medium interface circuit, the second unit comprises the wireless medium interface circuit, and quality of service measurements of the wireless medium are transmitted from the second unit to the first unit according to a frame based standard.

In some embodiments the exemplary communications apparatus further comprises a second wired medium interface circuit configured to communicate data over a second wired medium different than the first wired medium, and a third medium access controller having a third MAC address and configured to control the second wired medium interface circuit. In some of these embodiments the first and second wired medium interface circuits both form part of a first System on a Chip and the wireless medium interface circuit forms part of a second System on a Chip. Also in some of these embodiments the first and second wired medium interface circuits form part of the same System on a Chip with an on chip communication means between each subsystem providing for communication according to a frame based standard.

An exemplary network of the invention comprises at least two nodes in communication with each another over a first wired medium and over a wireless medium. Here, each node includes a first medium access controller having a first MAC address, a second medium access controller having a second MAC address, and a communications controller configured receive data packets and to apportion the data packets between the first and second medium access controllers based on a quality of service measure of the first wired or wireless medium in order to provide simultaneous data transmission over the first wired medium and the wireless medium. Other nodes of the network may communicate with the at least two nodes only over the first wired medium, or only over the wireless medium.

Either or both of the at least two nodes may comprise a third medium access controller having a third MAC address, and in these embodiments the at least two nodes may communicate with each other additionally over a different wired medium. In these embodiments the network may comprise additional nodes that are configured to communicate with the at least two nodes only over the different wired medium, or over the different wired medium in combination with either or both of the other wired medium and the wireless medium.

Another exemplary network of the invention comprises at least first and second communications apparatus as set forth above, the first and second communications apparatus being in data communication with each other by way of each of a power line medium and a wireless medium, each constituting a node on the network. In various embodiments the network comprises a multi-media network. In various embodiments the network further comprises at least one node connected to the network by way of the wireless medium only, or by way of the power line medium only, and each node comprises routing information for each other node connected to the same communication medium, and where all of the nodes connected to the power line medium comprise routing information to all other nodes in the network regardless of the medium or media that the other nodes are connected.

In various embodiments the network comprises a wireless only node connected to the network by way of the wireless medium only and comprises a power line only node connected to the network by way of the power line medium only, and in these embodiments the network is configured to communicate data from the wireless only node to the power line only. In these embodiments one of the first or second communications apparatus is designated as an access point for the wireless medium and provides a list of MAC addresses to the other nodes connected to the power line medium. Additionally, the nodes connected to the wireless medium send data to the node designated as the access point which receives the data through a wireless medium interface circuit. Further, the access point is configured to determine whether the received data is addressed to a node on the wireless network, and if not, sends the data to a power line medium interface circuit over the layer II level link for transmission over the power line medium to the intended node.

### BRIEF DESCRIPTION OF THE DRAWINGS

FIG. 1 shows a communications network according to an exemplary embodiment of the present invention.

FIG. 2 shows a representation of physical and medium access control layers of a communications apparatus according to an exemplary embodiment of the present invention.

FIG. 3 shows a representation of physical and medium access control layers in a communications apparatus according to another exemplary embodiment of the present invention.

### DETAILED DESCRIPTION

A communications apparatus provide simultaneous data communications over both a power line medium and wirelessly. The power line and wireless interfaces may operate asynchronously of each other. Thus, the communications apparatus can improve performance by splitting data between both the power line medium and the wireless medium.

More specifically, in various embodiments the communications apparatus comprises a routing controller that includes routing data, where the routing data specifies an identity of an apparatus with which the communications apparatus is to communicate, such as a second communications apparatus. Where the two communications apparatus form part of a network, the routing data may be in the form of a routing table containing device identifications for each of the other communications apparatus of the network. Hence, possible paths other than a path between the two communications apparatus may be effectively disabled. Therefore, there may be no need for a protocol, such as the spanning tree protocol, to avoid the formation of data loops.

In various embodiments the communications controller may be a system medium access controller configured to control each of a first medium access controller and a second medium access controller. The first medium access controller has a first MAC address and is configured to control a first medium interface circuit that is configured to communicate data over a wired medium. The wired medium may be, for example, a power line, a twisted pair, or a coaxial cable. Similarly, the second medium access controller has a second MAC address and is configured to control a second medium interface circuit that is configured to communicate data wirelessly, and in some embodiments the second medium interface circuit is 802.11 compliant. In various embodiments, the first medium interface circuit and the second medium interface circuit are linked at the layer II level of the OSI model.

The first medium access controller and the first medium interface circuit may be formed as part of a first unit, such as a first System on a Chip (SoC), and the second medium access controller and the second medium interface circuit may be formed as part of a second unit, such as a second System on a Chip (SoC). Alternatively, the first and second medium access controllers and the first and second interface circuits may form part of a single System on a Chip (SoC). In some embodiments, the communications controller may form part of the first unit, while in other embodiments the communications controller may form part of the second unit.

In various embodiments the first unit comprises a third medium interface circuit configured to communicate data over a different wired medium than the first medium interface circuit. In these embodiments the first unit can comprise a convergence layer controller configured to control medium access controllers associated with the first and third medium interface circuits.

In various embodiments, communications between the first and second units may be achieved according to a frame based standard, such as Ethernet according to the 802.3 standard. The Ethernet standard may be transmitted across one of several inter system connections, such as one of the following: MII, RMII, RvMII, GMII, RGMII, SMII, 10/100, 10/100/1000, USB1.1, USB2, USB3, SDIO, PCIe and PCI. Data may be split between the first and second medium interface circuits based on a quality of service measure. The quality of service measure may comprise at least one of: bandwidth, medium latency, extent of packet loss, a type of data to be communicated (e.g. movie or audio), and a condition of the data to be communicated. Methods for determining quality of service metrics are described, for example, in WO 2008/142450 and WO 2008/142449, both incorporated herein by reference.

Where data is apportioned based on a quality of service measure that depends on a condition of at least one of the power line medium and the wireless medium, the communications apparatus may comprise at least one of a first medium access controller that is configured to obtain information regarding the power line medium, and a second medium access controller that is configured to obtain information regarding the wireless medium. More specifically, the communications apparatus may be operative to convey such media information to the communications controller. Where the communications controller forms part of one of a first unit comprising a first medium interface circuit and a second unit comprising a second medium interface circuit, the information obtained from a medium may be conveyed from one unit to the other over a communications link operating according to a frame based standard, such as Ethernet.

Alternatively or in addition, the communications apparatus may comprise at least a third medium interface circuit that is configured to communicate data over a different medium than the wired and the wireless media. More specifically, the third medium interface circuit may be configured to communicate data over a wired medium that is different than the wired medium of the first medium interface. For example, the first medium interface circuit may be configured to communicate data over a power line while the third medium interface circuit may be configured to communicate data over a coaxial cable. The first and third medium interface circuits may both form part of a first System on a Chip (SoC) and the second medium interface circuit may form part of a second System on a Chip (SoC). Alternatively, the first to third medium interface circuits may form part of the same System on a Chip (SoC) with an on-chip communication means between each subsystem providing for communication according to a frame based standard, such as Ethernet. Alternatively or in addition, a medium interface circuit may be configured to operate as a transceiver. Thus, the medium interface circuit in these embodiments may be configured to either receive or transmit data.

In various embodiments, a network apparatus comprises at least a first and a second communications apparatus as above, the first and second communications apparatus being in data communication with each other by way of each of a power line medium and a wireless medium. Thus, both the power line medium and the wireless medium provide a communications path between the first and second communications apparatus. More specifically, the network apparatus may be a multi-media network apparatus suitable for a residential or a commercial building.

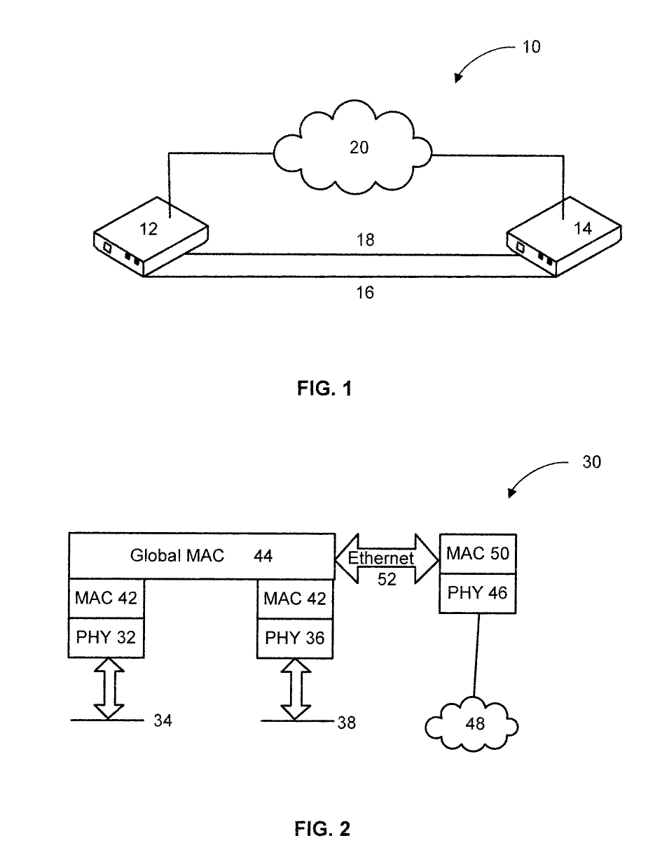

FIG. 1 shows a first node 12 and a second node 14 (each constituting a communications apparatus) of a communications network 10. The network 10 can be deployed in a residence or a business, for example. Each node 12, 14 may be a consumer electronics product such as a television. The communications network 10 comprises further un-illustrated nodes that are connected to each other and to the nodes 12, 14 in the same fashion that the nodes 12, 14 are connected to each other. The first and second nodes 12, 14 are connected by a power line cable 16 (which constitutes a power line medium), a coaxial cable 18 (which constitutes a third communications medium), and a wireless connection 20 (which constitutes a wireless medium). The network 10 provides communication between and amongst nodes in a plurality of rooms in the building. Each of the nodes may comprise a different multi-media device, in some embodiments. Thus, for instance, the first node 12 can comprise a Home Gateway (HGW) while the second node 14 comprises an audio-visual entertainment apparatus.

Each of the first node 12 and second node 14 can comprise a home networking integrated circuit (e.g., a GGL541 from Gigle Networks Ltd of Capital House, 2 Festival Square, Edinburgh, EH3 9SU, UK) provided within an appropriate enclosure. The home networking integrated circuit provides for communication over the wired communications media as is described below in more detail. Each of the first node 12 and the second node 14 also can comprises a wireless communications circuit that is operable according to at least one of the 802.11 standards, such as 802.11a, 802.11b, 802.11g, 802.11n, etc. Each network node is configured to communicate with a consumer product by way of an Ethernet communications controller and with the other nodes in the network 10 over the communications media shown in FIG. 1. In some embodiments, each node 12, 14 comprises a routing controller that includes routing data in the form of a routing table containing device identifications for each of the other nodes in the network 10. The routing table is operative to identify, within the network 10, a receiving node that is to receive data. Hence, all possible paths other than a path between the two nodes 12, 14 are effectively disabled.

An exemplary embodiment of a node 30 is represented in FIG. 2 to illustrate the physical and medium access control levels. Node 30 comprises a power line medium transceiver 32 (which constitutes a first medium interface circuit) configured to interface with a power line cable 34. Node 30 also comprises a coaxial cable interface circuit 36 (which constitutes a third medium interface circuit) configured to interface with a coaxial cable 38. The power line medium transceiver 32 is controlled by a first Medium Access Controller (MAC) 40 and the coaxial cable interface circuit 36 is controlled by a third Medium Access Controller (MAC) 42. A system Medium Access Controller 44 (which constitutes a communications controller) controls the splitting of data for transmission over the power line, the coaxial, and the wireless media, as is described below in more detail. The components described above can comprise part of a first System on a Chip (SoC) (which constitutes a first unit) in some embodiments.

The node 30 of FIG. 2 can further comprise an 802.11 compliant transceiver 46 (which constitutes a second medium interface circuit), which is configured to communicate over the wireless medium 48. The 802.11 compliant transceiver 46 is controlled by a second Medium Access Controller (MAC) 50. The 802.11 compliant transceiver 46 and the second Medium Access Controller 50 form part of a second System on a Chip (SoC), which constitutes a second unit, in some embodiments. Communication between the system Medium Access Controller 44 and the second Medium Access Controller 50 is by way of an Ethernet connection 52.

Exemplary methods of operation will now be described with reference to FIGS. 1 and 2. As one example, a movie (encoded in an MPEG standard format, for instance) is to be transmitted from the first node 12 to second node 14. Each of the first and third Medium Access Controllers 40, 42 is configured to obtain information from its respective channel relating to quality of service measures, such as available bandwidth, latency and the extent of packet loss. Also, the second Medium Access Controller 50 is configured to obtain information relating to quality of service measures, such as available bandwidth, latency and extent of packet loss over the wireless medium 48. Quality of service information is transmitted from the second Medium Access Controller 50 to the system Medium Access Controller 44 by way of the Ethernet connection 52 at layer II of the OSI model.

A quality of service metric is determined, for example, as described in WO 2008/142450 or WO 2008/142449. The system Medium Access Controller 44 apportions the data amongst the power line cable, the coaxial cable and the wireless connection based on factors such as the type of data being transmitted (a movie in this example) and the determined quality of service information in order to optimize throughput. For example, if the available bandwidths of the power line medium and the wireless medium are equal, the data can be split evenly such that each medium carries half of the data.

The split data is then transmitted over the three media simultaneously. It will be appreciated that more than one flow of data (e.g. more than one movie) can be simultaneously transmitted and/or received, that is, communicated between the first and second nodes 12, 14. Data can be received and/or transmitted using any combination of media in an asynchronous fashion. Thus, for example, the first and second media can be used to transmit while the third medium is used to receive or the first medium could be used to transmit and the second and third media used to receive. Alternatively, the first and third media could be used to receive while the second medium is used to transmit. Also, one of the media may not be used such that, for example, the third medium is not used while the first and second media are both used to transmit or receive or the third medium is not used while one of the first and second media is used to transmit and the other of the first and second media is used to receive.

The following example of inter-node communication will serve to further illustrate how nodes actually communicate with each other within network 10. In this example, a node 1 has a PLC MAC address 100 and Wi-Fi MAC address 110, and comprises a Wi-Fi access point. A node 2 is a Wi-Fi only node having a Wi-Fi MAC address 200. A node 3 is a PLC only node having a PLC MAC address 300. A node 4 has PLC MAC address 400 and Wi-Fi MAC address 410.

To communicate from node 2 to node 3, node 1 initially publishes to the other PLC nodes 3 and 4 that it has access to MAC addresses 200, 300, 400, and 410 (regardless of the medium through which the MAC address is accessible to node 1). Node 2 (MAC address 200) is a Wi-Fi only node, and all Wi-Fi nodes are required to send their data to the access point, node 1, thus node 1 receives over the wireless medium the data addressed to MAC address 300. Since this data is destined for a MAC address that is not known to the Wi-Fi network, node 1 sends the data through the Ethernet interface 52 to the system medium access controller 44 and then on, through its PLC interface 32, to node 3 at MAC address 300.

It should be noted that at no point does a node that is on more than one network appear to have a single MAC address. For communication in their respective medium, each node retains its MAC address for that medium. However, on the PLC side of the network, tables of all visible MAC address are maintained which have both Wi-Fi and PLC addresses in the same table such that, for routing purposes, they are treated as addresses of a single network. Therefore, in other words, the Wi-Fi network can be viewed as a “slave” to the PLC network.

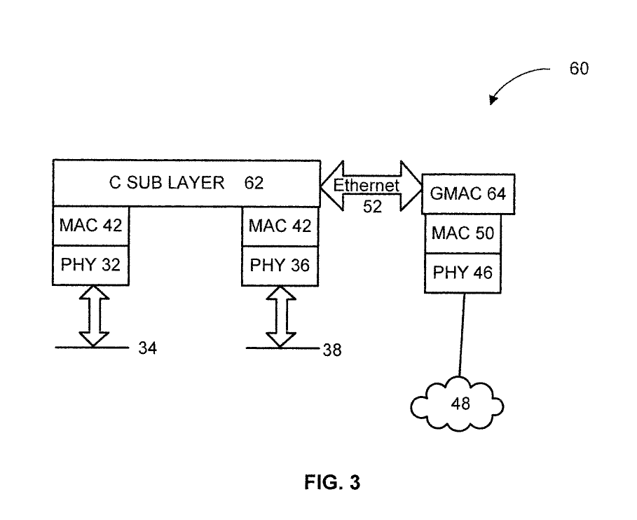

An exemplary embodiment of a node 60 is represented in FIG. 3. Components of node 60 that are common to node 30 (FIG. 2) are designated by like reference numerals. In contrast with node 30, node 60 comprises a convergence layer controller 62 instead of the system medium access controller 44. The convergence layer controller 62 is configured to control the first and third medium access controllers 40, 42. The system medium access controller 64 of the second embodiment is associated with the wireless communications sub-system and thus forms part of the second System on a Chip. Communications between the first and second System on a Chip is by way of an Ethernet connection 52.

Operation of node 60 is the same as the operation of node 30, with the exception that quality of service information for the power line 34 and coaxial cable 38 are transmitted over the Ethernet connection 52 to the system medium access controller 64 in the second System on a Chip. As with node 30, the system medium access controller 64 of node 60 is configured to apportion data amongst the three media based on the type of data being transmitted (i.e. a movie) and the determined quality of service information. The apportioned data is then simultaneously transmitted over the three media.

In making a layer II connection through the Ethernet interface 52 between the first System on a Chip and the second System on a Chip, the linked networks over the different media effectively become a single logical network. However, it should be noted that, in the above exemplary embodiments, each system retains its own MAC address and therefore each still belongs to its own medium network. In this respect, each node maintains a separate MAC address when seen by any other node in the respective wireless or power line networks.

In addition to the spreading of data across both wired and wireless media as described above, data packets can also be routed over different media as described in WO 2007/039723. Furthermore, the network and the network nodes can be configured to switch between ordinary and power saving modes as described in each of GB 0914773.7, GB 0914775.2, and GB 0914774.5.

The embodiments discussed herein are illustrative of the present invention. As these embodiments of the present invention are described with reference to illustrations, various modifications or adaptations of the methods or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A communications apparatus comprising:
a first wired medium interface circuit configured to communicate data over a first wired medium;
a first medium access controller having a first MAC address and configured to control the first wired medium interface circuit;
a wireless medium interface circuit that is 802.11 compliant and configured to communicate data wirelessly;
a second medium access controller having a second MAC address and configured to control the wireless medium interface circuit; and
a communications controller configured receive data packets and to apportion the data packets between the first and second medium access controllers to provide simultaneous data transmission over the first wired medium and wirelessly by way of the first wired medium interface circuit and the wireless medium interface circuit, wherein the first wired medium interface circuit and the wireless medium interface circuit are linked at the layer II level of the OSI model.

2. The communications apparatus of claim 1 further comprising a routing controller.

3. The communications apparatus of claim 1 wherein the first wired medium comprises a power line.

4. The communications apparatus of claim 1 wherein the first wired medium comprises a coaxial cable.

5. The communications apparatus of claim 1 wherein the first wired medium interface circuit and the wireless medium interface circuit are configured to communicate with one another using the Ethernet 802.3 standard.

6. The communications apparatus of claim 1 wherein the first and second medium access controllers and the wired and wireless medium interface circuits form part of a single System on a Chip.

7. The communications apparatus of claim 1 wherein the first medium access controller and the first wired medium interface circuit are formed as part of a first System on a Chip and the second medium access controller and the wireless medium interface circuit are formed as part of a second System on a Chip.

8. The communications apparatus of claim 7 wherein the communications controller forms part of the first System on a Chip.

9. The communications apparatus of claim 7 wherein the communications controller forms part of the second System on a Chip.

10. The communications apparatus of claim 9 wherein the first System on a Chip comprises
a second wired medium interface circuit that is configured to communicate data over a second wired medium different than the first wired medium,
a third medium access controller having a third MAC address and configured to control the second wired medium interface circuit, and
a convergence layer controller configured to control the first and third medium access controllers.

11. The communications apparatus of claim 7 wherein the first and second Systems on a Chip are configured to communicate with one another using a frame based standard.

12. The communications apparatus of claim 1 wherein the communications controller is configured to apportion the data packets based on a quality of service measure.

13. The communications apparatus of claim 12 wherein the quality of service measure comprises at least one of a bandwidth, a medium latency, an extent of packet loss, a type of data to be communicated, and a condition of the data to be communicated.

14. The communications apparatus of claim 1 wherein the first medium access controller is configured to measure a quality of the first wired medium, or the second medium access controller is configured to measure a quality of the wireless medium.

15. The communications apparatus of claim 1 wherein a first unit includes the communications controller and the first wired medium interface circuit, a second unit comprises the wireless medium interface circuit, and wherein quality of service measurements of the wireless medium are transmitted from the second unit to the first unit according to a frame based standard.

16. The communications apparatus of claim 1 further comprising
a second wired medium interface circuit configured to communicate data over a second wired medium different than the first wired medium, and
a third medium access controller having a third MAC address and configured to control the second wired medium interface circuit.

17. The communications apparatus of claim 16 wherein the first and second wired medium interface circuits both form part of a first System on a Chip and the wireless medium interface circuit forms part of a second System on a Chip.

18. The communications apparatus of claim 16 wherein the first and second wired medium interface circuits form part of the same System on a Chip with an on chip communication means between each subsystem providing for communication according to a frame based standard.

19. The communications apparatus of claim 1 wherein the first wired medium interface circuit or the wireless medium interface circuit is configured to operate as a transceiver.

20. A network comprising:
at least two nodes in communication with each another over a first wired medium and over a wireless medium, each node including
a first medium access controller having a first MAC address,
a second medium access controller having a second MAC address, and
a communications controller configured receive data packets and to apportion the data packets between the first and second medium access controllers based on a quality of service measure of the first wired or wireless medium in order to provide simultaneous data transmission over the first wired medium and the wireless medium.

21. A method comprising:
a first node, comprising a wireless access point, publishing a list of MAC addresses, the list including MAC addresses for other nodes in communication with the first node over either or both of a wired medium and a wireless medium, the list being published to those other nodes that are in communication with the first node over the wired medium;
receiving over the wireless medium, by the first node, a data packet stream, each data packet of the stream addressed to a MAC address for one of the other nodes in communication with the first node over the wired medium; and
transmitting some data packets of the data packet stream from the first node to the MAC address over the wired medium.

22. The method of claim 21 further comprising communicating the data packet stream from a first medium access controller of the first node to a second medium access controller of the first node using a frame based standard.

23. The method of claim 21 further comprising also transmitting other data packets of the data packet stream from the first node over the wireless medium to a node associated with the MAC address.

24. The method of claim 23 wherein the data packets of the data packet stream received by the first node are apportioned to be transmitted to the node associated with the MAC address over either the wireless medium or over the wired medium.

25. The method of claim 24 wherein the data packets are apportioned based on a quality of service measure.
